(19) United States
(12) Patent Application Publication
(10) Pub. No.: US 2014/0217286 A1
(43) Pub. Date: Aug. 7, 2014

(54) DETECTION SYSTEM FOR DROPPING OBJECTS

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: JIAN ZHAO, Wuhan (CN); CHONG HE, Wuhan (CN); XIAO-HUI WANG, Wuhan (CN); WEN-JUN HU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/963,008

(22) Filed: Aug. 9, 2013

(30) Foreign Application Priority Data
Jan. 24, 2013 (CN) 2013100267395

(51) Int. Cl. G01J 5/20

(52) U.S. Cl. CPC G01J 5/20
USPC 250/338.1

(57) ABSTRACT

A system for the detection of fast-moving dropping objects includes a submitting plate, a receiving plate, and a microcontroller. The submitting plate includes a first submitting pipe, a second submitting pipe, and a third submitting pipe. The first, second, and third submitting pipes emit infrared rays in turn. The receiving plate includes a first receiving pipe, a second receiving pipe, and a third receiving pipe. An object passage is defined between the receiving plate and the submitting plate, and the activation of the submitting pipes in turn detects individual objects even if one of a number of the falling objects obscures another falling object.

### BACKGROUND

1. Technical Field

The present disclosure relates to detection systems, and particularly to a detection system for an object dropping.

2. Description of Related Art

Infrared rays are used in various fields, such as vending mechanisms. In a vending mechanism, infrared beams being made or broken determines whether an object is normally out of a passage in the vending mechanism. Generally, the vending mechanism comprises a submitting plate with a submitting module, a receiving plate with a receiving module and a microcontroller. The object path or passage is defined between the submitting plate and the receiving plate. When the object passes through the passage, the infrared ray emitted by the submitting module is transmitted to the receiving module, and the microcontroller records the exit of an object from the passage in the vending mechanism. However, when the object passes through the object passage, the object may break the infrared ray, and the receiving module can not timely receive the infrared ray emitted by the submitting module. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a detection system in accordance with an embodiment.

FIG. 2 is a circuit view of the detection system of FIG. 1.

FIG. 3 is a schematic view of the detection system of FIG. 1.

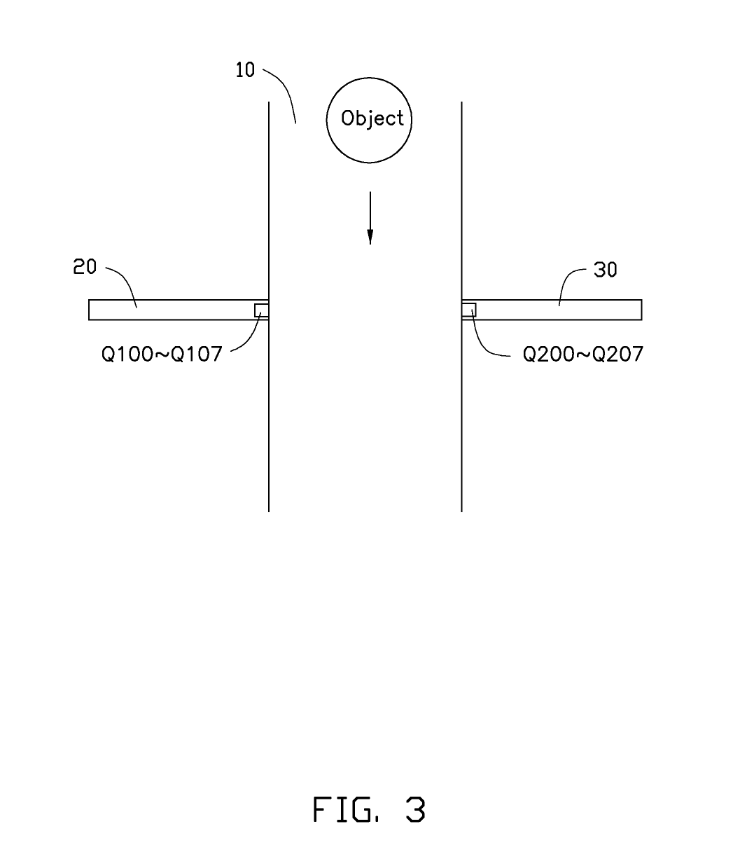

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

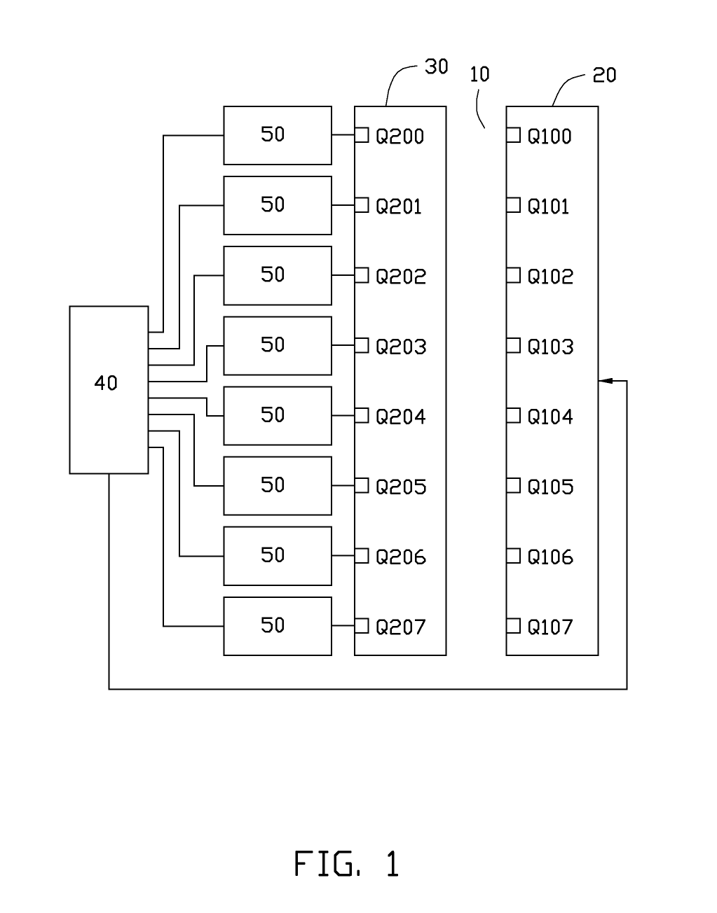

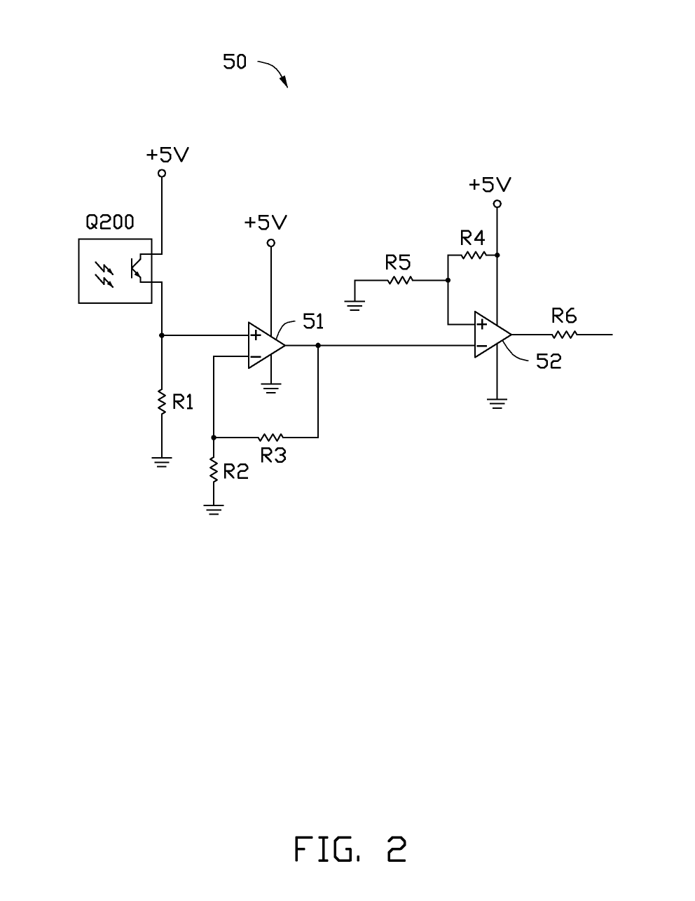

FIGS. 1-2 illustrate a detection system in accordance with an embodiment. The detection system defines an object passage 10 and comprises a submitting plate 20, a receiving plate 30, a microcontroller 40, and a plurality of circuit boards 50. The microcontroller 40 is connected to the submitting plate 20 and the receiving plate 30, and the plurality of circuit boards 50 are connected to the receiving plate and the microcontroller 40. In one embodiment, the submitting plate 20 is substantially parallel to the receiving plate 30, and the plurality of circuit boards 50 comprises eight circuit boards 50.

The submitting plate 20 comprises a plurality of submitting pipes, such as eight submitting pipes Q100-Q107 arranged one after the other and located on a first straight line that is substantially parallel to the submitting plate 20. The receiving plate 30 comprises a plurality of receiving pipes, such as eight receiving pipes Q200-Q207 corresponding to the eight submitting pipes Q100-Q107 and located on a second straight line that is substantially parallel to the receiving plate 30. In one embodiment, each of the eight receiving pipes Q200-Q207 is an optical coupler.

Each of the eight receiving pipes Q200-Q207 is connected to a circuit board 50. For example, the receiving pipe Q200 is connected to a circuit board 50. The circuit board 50 comprises an operational amplifier 51 and a comparator 52 connected to the operational amplifier 51. A controlling signal generated by the microcontroller 40 is transmitted to illuminate the submitting pipes Q100-Q107. A collector of the Q200 is connected to a power Vcc. An emitter of the Q200 is connected to the ground via a first resistor R1. A positive terminal of the operational amplifier 51 is connected to the emitter of the Q200, and a negative terminal of the operational amplifier 51 is connected to ground via a second resistor R2. The second resistor R2, connected to a third resistor R3 in series, is connected to an output terminal of the operational amplifier 51. The output terminal of the operational amplifier 51 is connected to a negative terminal of the comparator 52. A positive terminal of the comparator 52 is connected to a second power Vcc via the fourth resistor R4, and connected to the ground via a fifth resistor R5. An output terminal of the comparator 52 is connected to the microcontroller 40 via a sixth resistor R6.

The operation principle of the detection system is that a controlling signal and a high level signal are generated by the microcontroller 40 to illuminate the submitting pipe Q100. The receiving pipes Q200 receive the light from the submitting pipes Q100 and generate a current I0. The current I0 flows through the first resistor R1 and generates a voltage U0, U0=I0*R1. An output voltage U1 of the operational amplifier 51 is determined by the second resistor R2 and the third resistor R3, U1=U0*(R2+R3)/R2. In one embodiment, a resistance value of the second resistor R2 is 39 KΩ, and a resistance value of the third resistor R3 is 10 KΩ. Therefore, the output voltage U1 of the operational amplifier 51 U1=U0*(39+10)/10=4.9*U0. The output terminal of the operational amplifier 51 is connected to the negative terminal of the comparator 52. Thus, an input voltage of the negative terminal of the comparator 52 is equal to U1. The second power voltage U2 equals 5V. An input voltage U2 of the positive terminal of the comparator 52 is determined by the fourth resistor R4 and the fifth resistor R5, that is, U3=U2*R5/(R4+R5). In one embodiment, a resistance value of the fourth resistor R4 is 39 KSΩ, and a resistance value of the fifth resistor R5 is 10 KΩ. Thus, U3=5*20/(10+20)=3.3V. An output voltage of the comparator 52 is determined by the U1 and the U3. When the U3<U1, a low level voltage flows out of the output terminal of the comparator 52. When the U3>U1, a high level voltage flows out of the output terminal of the comparator 52. The output voltage of the comparator 52 is transmitted to the microcontroller 40, and the microcontroller 40 detects the output voltage of the comparator 52. When the low level voltage flows out of the output terminal of the comparator 52, the microcontroller 40 detects the light, which signifies that no object has dropped into the object passage 10. When the high level voltage flows out of the output terminal of the comparator 52, the microcontroller 40 can detect no light, which means that an object has dropped into the object passage 10.

Then, a controlling signal and a high level voltage are generated by the microcontroller 40 to illuminate the submitting pipe Q101, and an infrared rays is transmitted to the submitting pipes Q100-Q102 via the submitting pipe Q101. If a high level voltage flows out of one of the receiving pipes Q200, Q201, the microcontroller 40 determines that light has been detected, and that an object has dropped into the object passage 10.

The microcontroller 40 repeats eight times and generates eight controlling signals, and the infrared rays are emitted in turn from each of the submitting pipes Q100-Q107. A time of emission of the infrared rays from each of the submitting pipes Q100-Q107 can last 180 us. Therefore, the receiving pipes Q200-Q201 receive the infrared rays emitted by the submitting pipe Q100. The receiving pipes Q200-Q202 receive the infrared rays emitted by the submitting pipe Q101. The receiving pipes Q201-Q203 receive the infrared rays emitted by the submitting pipe Q102. The receiving pipes Q202-Q204 receive the infrared rays emitted by the submitting pipe Q103. The receiving pipes Q203-Q205 receive the infrared rays emitted by the submitting pipe Q104. The receiving pipes Q204-Q206 receive the infrared rays emitted by the submitting pipe Q105. The receiving pipes Q205-Q207 receive the infrared rays emitted by the submitting pipe Q106. The receiving pipes Q206-Q207 receive the infrared rays emitted by the submitting pipe Q107.

In one embodiment, five objects or pieces in close proximity to each other drop. A thickness of each of the five pieces is 1 cm. The five pieces drop from a height of 1.2 m, and pass through the object passage 10 in 2 ms. In fact, a reaction time of each of the eight submitting pipes Q100-Q107 is about 120 us. Each of the eight submitting pipes Q100-Q107 can emit light in 180 us, so the total of the eight submitting pipes Q100-Q107 can emit light in 1.44 ms. Even if the five pieces miss the top seven receiving pipes Q200-Q206 and reach to the eighth pipe Q207, 1.44 ms of time has passed. At this time, a shielding time for the five pieces is 1.56 ms (1.44+0.12=1.56). However, the five pieces pass through the object passage 10 in 2 ms. Therefore, the shielding time (1.56 ms) is less than the time (2 ms) that the five pieces are detectable, and the detection system can detect the objects and their state.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A detection system comprising:
a submitting plate comprising a first submitting pipe, a second submitting pipe, and a third submitting pipe; and the first submitting pipe, the second submitting pipe, and the third submitting pipe are configured to emit infrared rays in turn;
a receiving plate comprising a first receiving pipe, a second receiving pipe, and a third receiving pipe; and an object passage defined between the receiving plate and the submitting plate, and the object passage configured for dropping an object; and
a microcontroller connected to the submitting plate and the receiving plate;
wherein the first receiving pipe and the second receiving pipe are configured to receive a first infrared rays emitted by the first submitting pipe; the first receiving pipe, the second receiving pipe, and the third receiving pipe are configured to receive a second infrared rays emitted by the second submitting pipe; the second receiving pipe and the third receiving pipe are configured to receive a third infrared rays emitted by the third submitting pipe; and the microcontroller is configured to determine whether the object drops through the object passage according to an electrical level generated by one of the first infrared rays, the second infrared rays, and the third infrared rays from the first receiving pipe, the second receiving pipe and the third receiving pipe.

2. The detection system of claim 1, wherein the submitting plate further comprises a fourth submitting pipe; the receiving plate further comprises a fourth receiving pipe corresponding to the fourth submitting pipe; the second receiving pipe, the third receiving pipe and the fourth receiving pipe are configured to receive the third infrared rays emitted by the third submitting pipe; and the third receiving pipe and the fourth receiving pipe are configured to receive a fourth infrared rays emitted by the fourth submitting pipe.

3. The detection system of claim 1, wherein the submitting plate is substantially parallel to the receiving plate.

4. The detection system of claim 2, further comprising a first circuit board connected to the first receiving pipe, wherein the first circuit board comprises an operational amplifier and a comparator connected to the operational amplifier; a positive input terminal of the operational amplifier is connected to the first receiving pipe; a negative output terminal of the operational amplifier is connected to a negative input terminal of the comparator; and a positive output terminal of the comparator is connected to the microcontroller.

5. The detection system of claim 4, wherein each of the first receiving pipe, the second receiving pipe, the third receiving pipe, and the fourth receiving pipe is an optical coupler; and a collector of the optical coupler is connected to a first power; an emitter of the optical coupler is connected to ground via a first resistor, and the emitter of the optical coupler is connected to the positive input terminal of the operational amplifier.

6. The detection system of claim 5, wherein the negative input terminal is connected to the ground via a second resistor; and the second resistor, connected to a third resistor in series, is connected to the negative output terminal of the operational amplifier.

7. The detection system of claim 6, wherein the negative output terminal of the operational amplifier is connected to the negative input terminal of the comparator, the positive input terminal of the comparator is connected to the ground via a fourth resistor;
and the positive input terminal of the comparator is connected to a second power via a fifth resistor, and the negative output terminal of the comparator is connected to the microcontroller via a sixth resistor.

8. A detection system comprising:
a submitting plate comprising a first submitting pipe, a second submitting pipe, and a third submitting pipe; the first submitting pipe, the second submitting pipe, and the third submitting pipe arranged at a first straight line substantially parallel to the submitting plate and are configured to emit infrared rayss in turn;
a receiving plate, substantially parallel to the submitting plate, comprising a first receiving pipe, a second receiving pipe, and a third receiving pipe; the first receiving pipe, the second receiving pipe, and the third receiving pipe arranged at a second straight line substantially parallel to the receiving plate; an object passage defined between the receiving plate and the submitting plate, and the object passage configured for dropping an object; and
a microcontroller connected to the submitting plate and the receiving plate;
wherein the first receiving pipe and the second receiving pipe are configured to receive a first infrared rays emitted by the first submitting pipe; the first receiving pipe, the second receiving pipe, and the third receiving pipe are configured to receive a second infrared rays emitted by the second submitting pipe; the second receiving pipe and the third receiving pipe are configured to receive a third infrared rays emitted by the third submitting pipe; and the microcontroller is configured to determine whether the object drops through the object passage according to an electrical level generated by one of the first infrared rays, the second infrared rays, and the third infrared rays from the first receiving pipe, the second receiving pipe and the third receiving pipe.

9. The detection system of claim 8, wherein the submitting plate further comprises a fourth submitting pipe; the receiving plate further comprises a fourth receiving pipe corresponding to the fourth submitting pipe; the second receiving pipe, the third receiving pipe and the fourth receiving pipe are configured to receive the third infrared rays emitted by the third submitting pipe; and the third receiving pipe and the fourth receiving pipe are configured to receive a fourth infrared rays emitted by the fourth submitting pipe.

10. The detection system of claim 9, further comprising a first circuit board connected to the first receiving pipe, wherein the first circuit board comprises an operational amplifier and a comparator connected to the operational amplifier; a positive input terminal of the operational amplifier is connected to the first receiving pipe; a negative output terminal of the operational amplifier is connected to a negative input terminal of the comparator; and a positive output terminal of the comparator is connected to the microcontroller.

11. The detection system of claim 10, wherein each of the first receiving pipe, the second receiving pipe, the third receiving pipe, and the fourth receiving pipe is an optical coupler;
a collector of the optical coupler is connected to a first power; an emitter of the optical coupler is connected to ground via a first resistor, and the emitter of the optical coupler is connected to the positive input terminal of the operational amplifier.

12. The detection system of claim 11, wherein the negative input terminal is connected to the ground via a second resistor, the second resistor, connected to a third resistor in series, is connected to the negative output terminal of the operational amplifier.

13. The detection system of claim 12, wherein the negative output terminal of the operational amplifier is connected to the negative input terminal of the comparator, the positive input terminal of the comparator is connected to the ground via a fourth resistor; the positive input terminal of the comparator is connected to a second power via a fifth resistor, and the negative output terminal of the comparator is connected to the microcontroller via a sixth resistor.
